(19) United States
(12) Patent Application Publication
(10) Pub. No.: US 2012/0000363 A1
(43) Pub. Date: Jan. 5, 2012

(54) Air filter device

(75) Inventors: Satoshi Mizutani, Nagoya-city (JP); Katsunori Iwase, Kariya-city (JP); Kazushi Shikata, Kariya-city (JP); Kenichi Kato, Nagoya-city (JP); Yoshinobu Suzuki, Aichi-gun (JP); Mika Kawakita, Obu-city (JP); Hajime Murakami, Los Altos, CA (US)

(73) Assignee: DENSO CORPORATION, Kariya-city (JP)

(21) Appl. No.: 13/135,200

(22) Filed: Jun. 28, 2011

(30) Foreign Application Priority Data
Jun. 30, 2010 (JP) 2010-149677

(51) Int. Cl. B01D 53/22

(52) U.S. Cl. 96/9; 96/4

(57) ABSTRACT

An air filter device includes a permeation film arranged at a boundary portion between an outside air passage and an inside air passage, such that one side surface of the permeation film is exposed to outside air in the outside air passage and the other side surface of the permeation film is exposed to inside air in the inside air passage. The permeation film is configured such that specific gas passes through the permeation film between the outside air passage and the inside air passage. Furthermore, a turbulent flow generation portion is provided to generate a turbulent flow in at least one of the outside air flowing through near the one side surface of the permeation film and the inside air flowing through near the other side surface of the permeation film.

### CROSS REFERENCE TO RELATED APPLICATION

This application is based on Japanese Patent Application No. 2010-149677 filed on Jun. 30, 2010, the contents of which are incorporated herein by reference in its entirety.

### TECHNICAL FIELD

The present invention relates to an air filter device that can selectively permeate gas of specific kind by using a permeation film between outside air and inside air.

### BACKGROUND

In a conventional air filter device, a permeation film is provided at the boundary between outside air and inside air, so as to selectively permeate specific gas (e.g., oxygen, carbon dioxide) between the outside air and the inside air, for example, in Patent Document 1 (JP 2010-120496A). In the air filter device described in Patent Document 1, when the oxygen concentration of inside air becomes lower than the oxygen concentration of outside air and the carbon dioxide concentration of the inside air becomes higher than the carbon dioxide concentration of the outside air due to the breathing of occupant in a vehicle compartment, the oxygen passes through the permeation film and is introduced to the vehicle compartment and the CO2 contained in the inside air is discharged to the outside of the vehicle compartment due to the concentration difference between the outside air and the inside air.

However, in the air filter device with the permeation film, if the fresh outside air and the inside air are not forcibly supplied to the permeation film, the outside air or the inside air may stay near the permeation film, and thereby it is difficult to generate the concentration difference between the outside air and the inside air. In this case, the permeation performance of the permeation film may be decreased. Thus, it may be necessary to provide a blower for blowing air to the permeation film on the inside air side and the outside air side. When the permeation film has a flat plate shape, the inside air and the outside air respectively flow in parallel with the surface of the permeation film, thereby causing the layer flow near the surface of the permeation film. With this, the flow stay of the outside air or the inside air is caused around the permeation film, and thereby molecule exchange efficiency is reduced.

The present invention is made in view of the above matters, and it is an object of the present invention to provide an air filter device with a permeation film in which a molecule exchange efficiency can be effectively improved.

According to an aspect of the present invention, an air filter device includes an outside air passage in which outside air flows, an inside air passage in which inside air flows, and a permeation film arranged at a boundary portion between the outside air passage and the inside air passage and configured to cause specific gas to pass through the permeation film between the outside air passage and the inside air passage. One side surface of the permeation film is exposed to the outside air in the outside air passage, and the other side surface of the permeation film is exposed to the inside air in the inside air passage. The air filter device further includes an outside air blower located to generate a flow of the outside air in the outside air passage, an inside air blower located to generate a flow of the inside air in the inside air passage, and a turbulent flow generation portion configured to generate a turbulent flow in at least one of the outside air flowing through near the one side surface of the permeation film and the inside air flowing through near the other side surface of the permeation film. Thus, it is possible to disturb the flow of at least one of the outside air flowing through the outside air passage and the inside air flowing through the inside air passage by using the turbulent flow generation portion. As a result, it can prevent inside air or outside air from staying near the surface of the permeation film, thereby improving molecule exchange efficiency in the permeation film.

For example, the turbulent flow generation portion may be disposed upstream of the permeation film in at least one of the outside air passage and the inside air passage. Furthermore, the turbulent flow generation portion may be protrusion portions provided on at least one of the one side surface and the other side surface of the permeation film.

Alternatively, the turbulent flow generation portion may be a vibrating member that causes the permeation film to be vibrated. In this case, the vibrating member may be configured to generate a self-excited vibration in the permeation film due to the flow of at least one of the outside air in the outside air passage and the inside air in the inside air passage, or may be configured to directly vibrate the permeation film.

The air filter device may be provided with a permeation film unit in which a plurality of the permeation films are stacked with each other, and the permeation film unit may have therein an inside air flow space arranged between adjacent permeation films and an outside air flow space arranged between adjacent permeation films. In this case, the turbulent flow generation portion may include a first turbulent flow generating part protruding toward upstream from an upstream end of the permeation film or protruding toward downstream from a downstream end of the permeation film in a flow direction of the inside air flowing in the inside air flow space, and a second turbulent flow generating part protruding toward upstream from an upstream end of the permeation film or protruding toward downstream from a downstream end of the permeation film in a flow direction of the outside air flowing in the outside air flow space. In addition, the first turbulent flow generating part may be provided at an upstream or downstream side of the inside air flow space to generate turbulent flow of outside air, and the second turbulent flow generating part may be provided at an upstream or downstream side of the outside air flow space to generate turbulent flow of inside air.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic sectional view showing an air conditioner for a vehicle according to a first embodiment of the invention;

FIG. 2 is a perspective view showing a permeation film unit according to the first embodiment;

FIG. 3 is a top view showing the permeation film unit according to the first embodiment;

FIG. 4 is a side view showing the permeation film unit according to the first embodiment; and

FIGS. 5A, 5B and 5C are perspective views showing examples of a permeation film according to a second embodiment of the invention.

### DETAILED DESCRIPTION OF THE PREFERRED EMBODIMENTS

### First Embodiment

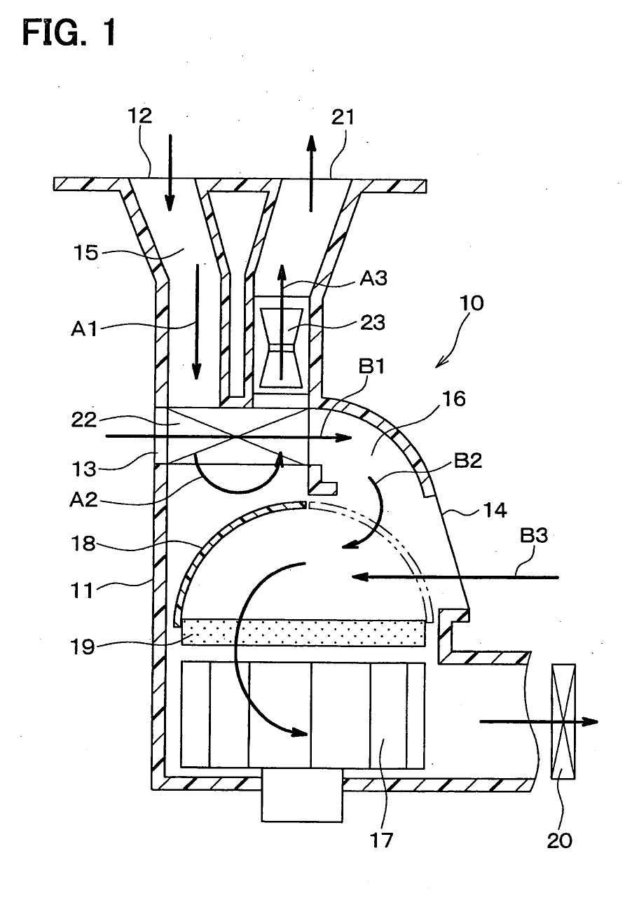

A first embodiment of the present invention will be described hereafter with reference to FIGS. 1 to 3. In the present embodiment, an air filter device is typically used for a vehicle air conditioner.

FIG. 1 is a schematic sectional view showing an air conditioner 10 for a vehicle according to the first embodiment. The vehicle air conditioner 10 includes an air conditioning case 11 arranged inside of a dash board (not shown) positioned at the frontmost portion of the vehicle compartment. The air conditioning case 11 defines therein an air passage through which air flows into the vehicle compartment. The air conditioning case 11 is made of a resin (e.g., polypropylene) having a suitable elasticity and being superior in the mechanical strength.

The air conditioning case 11 is provided with an outside air introduction port 12 through which outside air (i.e., air outside the vehicle compartment) is introduced into the air conditioning case 11, and first and second inside air introduction ports 13, 14 through which inside air (i.e., air inside the vehicle compartment) is introduced into the air conditioning case 11. The air conditioning case 11 defines therein an outside air passage 15 through which outside air introduced from the outside air introduction port 12 flows, and an inside air passage 16 through which inside air introduced from the inside air introduction ports 13, 14 flows.

A blower 17 for blowing air toward the vehicle compartment is disposed in the air conditioning case 11. An inside/outside air switching door 18 is disposed at an upstream air side of the blower 17, to open and close the outside air passage 15 and the inside air passage 16, and to change a flow ratio between an air amount of the inside air and an air amount of outside air. A filter 19 for removing dust or bad smell in air is arranged between the blower 17 and the inside/outside air switching door 18, as shown in FIG. 1.

In the present embodiment, the inside/outside air switching door 18 is configured by a rotary door. The inside/outside air switching door 18 is rotated so as to select an inside/outside air mode. The inside/outside air switching door 18 is operated by using a servomotor controlled by an air conditioning controller, or is manually driven by a passenger.

For example, as the inside/outside air mode, an inside air circulation mode or an outside air introduction mode may be set. In the inside air circulation mode, the inside/outside air switching door 18 closes the outside air passage 15 and opens the inside air passage 16. In contrast, in the outside air introduction mode, the outside air passage 15 is opened and the inside air-passage 16 is closed by the inside/outside air switching door 18. More specifically, in the inside air circulation mode, the inside/outside air switching door 18 is rotated to the solid line position of FIG. 1 to close the outside air passage 15, so that inside air is introduced to the blower 17 via the inside air passage 16. Furthermore, in the outside air introduction mode, the inside/outside air switching door 18 is rotated to the chain line position of FIG. 1 to close the inside air passage 16, so that outside air is introduced to the blower 17 via the outside air passage 15.

A heat exchanger 20 is arranged in the air conditioning case 11 at a position downstream of the blower 17, so as to cool and heat air blown by the blower 17. For example, a cooling heat exchanger for cooling air and a heating heat exchanger for heating air are used as the heat exchanger 20, and are disposed in the air conditioning case 11

In the present embodiment, an air mixing door may be arranged in the air conditioning case 11 to adjust a ratio of a flow amount of warm air passing through the heating heat exchanger and a flow amount of cool air bypassing the heating heat exchanger, thereby adjusting the temperature of air to be blown into the vehicle compartment. A downstream portion of the air conditioning case 11 is provided with plural air outlets so that conditioned air can be blown to a predetermined area in the vehicle compartment via the plural air outlets, and a mode switching door is arranged in the air conditioning case 11 to selectively open and close the plural air outlets.

The outside air passage 15 is formed in the air conditioning case 11, so that air flows approximately in U-shape via the outside air passage 15. Thus, in the inside air circulation mode, the inside/outside air switching door 18 closes the outside air passage 15, so that outside air flows in the outside air passage 15 to be U-turned as in the arrows A1, A2, A3 at a position upstream of the inside/outside air switching door 18. The outside air introduced from an outside air inlet 12 flows through the outside air passage 15 in a U-shape, and is discharged to the outside from the outside air outlet 21.

A permeation film unit 22 is arranged in a portion at which the outside air passage 15 is turned in a U-shape. An outside air blower 23 is disposed in the outside air passage 15 at a position downstream of the permeation film unit 22. In the outside air introduction mode, the flow of outside air is caused by an air conditioning blower 17, but the flow of inside air is not caused. In contrast, in the inside air circulation mode, the flow of inside air is generated by the air conditioning blower 17, and at the same time, the flow of outside air is also generated by the outside air blower 23. Thus, the air conditioning blower 17 can be adapted as an inside air blower that generates a flow of inside air in the inside air passage 16.

The permeation film unit 22 is disposed such that both the outside air flowing in the outside air passage 15 and the inside air introduced from the first inside air introduction port 13 pass. The inside air is introduced from the first inside air introduction port 13 to the permeation film unit 22 as in the arrow B1 of FIG. 1, and the inside air flowing out of the permeation film unit 22 flows through the inside air passage 16 as in the arrow B2 while being turned.

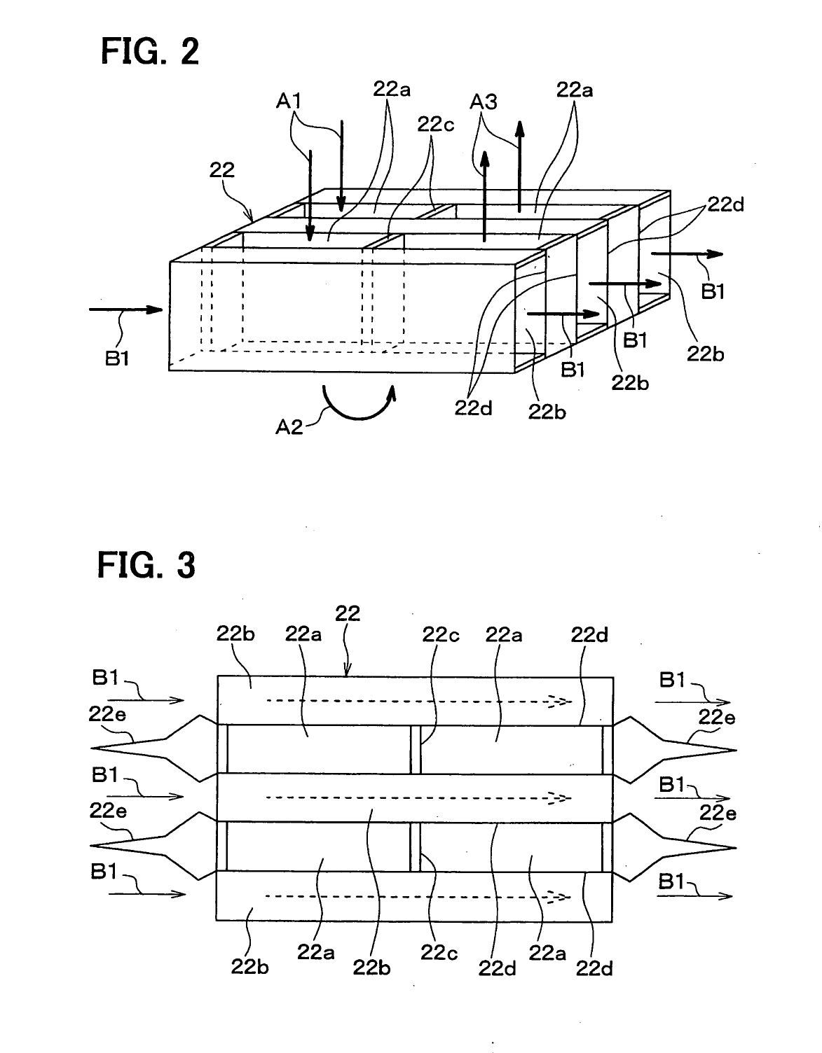

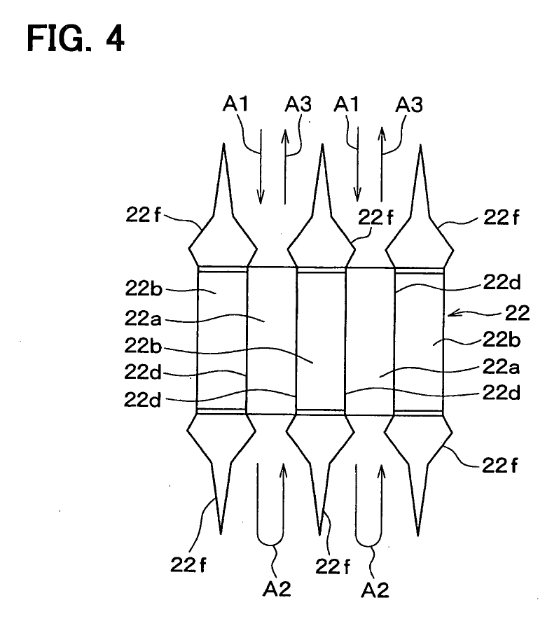

Next, the permeation film unit 22 will be described based on FIGS. 2 to 4. FIG. 2 is a perspective view showing the permeation film unit 22, FIG. 3 is a top view showing the permeation film unit 22, and FIG. 4 is a side view showing the permeation film unit 22. In FIG. 2, the turbulent flow generation portions 22e, 22f are not indicated.

As shown in FIG. 2, the permeation film unit 22 is formed into a rectangular parallelepiped shape as the whole shape. The permeation film unit 22 is provided with plural outside air flow spaces 22a and plural inside air flow spaces 22b. The outside air flow spaces 22a, through which outside air passes, and the inside air flow spaces 22b, through which inside air passes, are alternately arranged as a stack layer structure, in the permeation film unit 22. Thus, outside air flows in the permeation film unit 22 while being divided into the plural outside air flow spaces 22a. Therefore, the outside air flow spaces 22a are adapted as a part of the outside air passage 15 in which the outside air flows, and the inside air flow spaces 22b are adapted as a part of the inside air passage 16 in which the inside air flows.

In the example of FIG. 2, the outside air passes through the outside air flow spaces 22a vertically as in the arrows A1, A3, and the inside air passes through the inside air flow spaces 22b as in the arrows B1 perpendicular to the direction of the arrows A1, A3. Each outside air flow space 22a is partitioned by a partition plate 22c into two space parts in the flow direction B1. Thus, the outside air flowing in the direction shown by the arrow A1 in FIG. 2 is U-turned as in the arrow A2, and then flows in the direction shown by arrow A3.

In the permeation film unit 22, the permeation film 22d is positioned at a boundary portion between the outside air flow space 22a and the inside air flow space 22b, and the other parts except for the permeation film 22d is formed from a material such as resin.

Each permeation film 22d is made of a material in which the gas of specific kind (e.g., oxygen, carbon dioxide, water steam) easily permeates therethrough, but the gas of the other kind (e.g., nitrogen) is difficult to permeate therethrough. As the material of the permeation film 22d, a nonwoven fabric or a porous member such as a film made of a gas permeability macromolecule, a silicone material or a ceramic material can be used. The permeation film 22d has an outside air surface exposed to the outside air in the outside air flow space 22a, and an inside air surface exposed to the inside air in the inside air flow space 22b, so that the gas of specific kind within the outside air and the inside air can selectively pass through the permeation film 22d.

The permeation film 22d is configured to have a permeation performance due to a difference between the concentration of inside air and the concentration of outside air in the gas of the specific kind (e.g., oxygen, carbon dioxide, water stream). Furthermore, the permeation film 22d is configured to have the permeation performance even when a large pressure difference is not caused between the inside air side and the outside air side of the permeation film 22d by a pressure different generating unit such as a vacuum pump. That is, the permeation film 22 has the permeation performance even when a pressure difference is not caused between the inside air side and the outside air side of the permeation film 22d.

The permeation film 22d is formed into a fold plate shape such as a pleat fold plate shape, so as to increase the surface area of the permeation film 22d and improve the permeation performance. In addition, support members (not shown) made of a ceramics, a fiber, a porosity metal, a porosity resin or a resin screen mesh are laminated to support the permeation films 22d. The permeation film 22d is formed in a thin film shape so that the specific gas easily passes through the permeation film 22, and is supported by the support member.

The pore size of the surface and the inside of the permeation film 22d of the present embodiment is set equal to or lower than the mean free path of the penetration target gas (O₂, CO₂, H₂O). Here, the mean free path is a distance from the present collision of gas molecules to the next collision of gas molecules, and it is dependent on the kind of gas molecule. Thereby, when the gas penetrates through the permeation film 22d, a Knudsen flow becomes dominant in the flow of the gas. The “Knudsen flow” means the flow of thin gas, in which a motion of molecules poses a problem and the penetration speed of gas is dependent on the molecular weight. Thus, when the Knudsen flow becomes dominant, the permeation speed of the gas is changed based on the molecular weight.

The flow of the gas which penetrates the permeation film 22d changes to the viscous flow→the Knudsen flow→the dissolution diffusion flow as the pore size of the permeation film 22d becomes smaller. The pore size of the permeation film 22d, in which the Knudsen flow is caused, has a lowest dimension about 1 nm corresponding to the molecular size, and a highest dimension about 50 nm corresponding to the mean free path of the penetration target gas (O₂, CO₂, H₂O).

Because the “viscous flow” causes the gas to flow into the lower one from the higher one in the pressure, the direction through which gas flows is determined based on the pressure difference between the outside air and the inside air. For this reason, the gas (for example, N₂) which does not have a density difference between the outside air and the inside air also penetrates through the permeation film 22d based on the pressure difference between the inside air and the outside air, and thereby it is difficult for the specific gas (for example, oxygen, carbon dioxide, water steam) which has a density difference between the outside air and the inside air to selectively pass through the permeation film 22.

In contrast, because the “Knudsen flow” causes the gas to collide with wall surfaces of membranous holes before molecules collide to each other, the specific gas (for example, O₂, CO₂, H₂O), which has density difference between outside air and the inside air, can be made to selectively pass through the permeation film 22 in the Knudsen flow without being affected by the pressure difference between the outside air and the inside air. For this reason, it is possible for the specific gas to selectively pass through the permeation film 22d based on a density difference of the gas between the outside air and the inside air, by setting the pore size of the permeation film 22d to be not larger than the mean free path of penetration gas (O₂, CO₂, H₂O).

In addition, in the dissolution diffusion flow, because a gas molecule dissolves in the membranous upper surface and moves in a downstream direction by the molecular diffusion in the inside of a film, it is not affected by the influence of the pressure difference between the outside air and the inside air. However, the speed of the gas passing through the film becomes smaller, and thereby a membranous pore size becomes smaller toward downstream. For this reason, in order to secure the gas permeating speed, it is desirable for the pore size of the permeation film 22d to be enlarged, and thereby it is prefer that the molecule size is made larger than 1 nm, for example.

As shown in FIG. 3, a first turbulent flow generation portion 22e is provided at least at an inlet portion of the inside air flow space 22b of the permeation film unit 22, so as to cause a turbulent flow to the inside air flowing in the inside air flow space 22b. Similarly, as shown in FIG. 4, a second turbulent flow generation portion 22f is provided at least at an inlet portion of the outside air flow space 22a of the permeation film unit 22, so as to cause a turbulent flow to the outside air flowing in the outside air flow space 22a.

The first turbulent flow generation portion 22e is provided at an end portion of the outside air flow space 22a adjacent to the inside air flow space 22b, and the second turbulent flow generation portion 22f is provided at an end portion of the inside air flow space 22b adjacent to the outside air flow space 22a. That is, in the permeation film unit 22 in which the outside air flow space 22a and the inside air flow space 22b are alternately stacked, the first turbulent flow generation portion 22e is provided at a dividing surface which divides the flow of the inside air, and the second turbulent flow generation portion 22f is provided at a dividing surface which divides the flow of the outside air.

The first turbulent flow generation portion 22e is provided to protrude from the end portion of the outside air flow space 22a, and the second turbulent flow generation portion 22f is provided to protrude from the end portion of the inside air flow space 22b. Therefore, the first turbulent flow generation portion 22e is provided at least at an upstream side of the permeation film 22d in the flow direction of the inside air, and the second turbulent flow generation portion 22f is provided at least at an upstream side of the permeation film 22d in the flow direction of the outside air.

In each of the turbulent flow generation portions 22e, 22f of the present embodiment, the radial dimension is gradually enlarged from a tip end to a middle portion, and an enlarging ratio of the radial dimension becomes larger from the middle portion to a portion near the permeation film 22d. As shown in FIGS. 3 and 4, each of the turbulent flow generation portions 22e, 22f has a shape end portion and a protrusion portion protruding radially outside in a direction perpendicular to the air flow direction. The protrusion portion of the first turbulent flow generation portion 22e has two protrusion ends protruding to the inside air flow space 22b, and the protrusion portion of the second turbulent flow generation portion 22f has two protrusion ends protruding to the outside air flow space 22a. Thus, the first turbulent flow generation portion 22e disturbs the flow of the inside air flowing near the surface of the permeation film 22d in the inside air flow space 22b, and the second turbulent flow generation portion 22f disturbs the flow of the outside air flowing near the surface of the permeation film 22d in the outside air flow space 22a.

According to the first embodiment, turbulent flow can be generated in the outside air flowing in the outside air flow space 22a and in the inside air flowing in the inside air flow space 22b. Thus, it can prevent inside air and outside air from staying near the surfaces of the permeation film 22d, thereby improving the molecule exchange efficiency of the permeation film 22d. As a result, a necessary amount of ventilation for the gas required to pass through the permeation film 22d can be reduced, and thereby the sizes of the blowers 17 and 23 can be effectively reduced.

### Second Embodiment

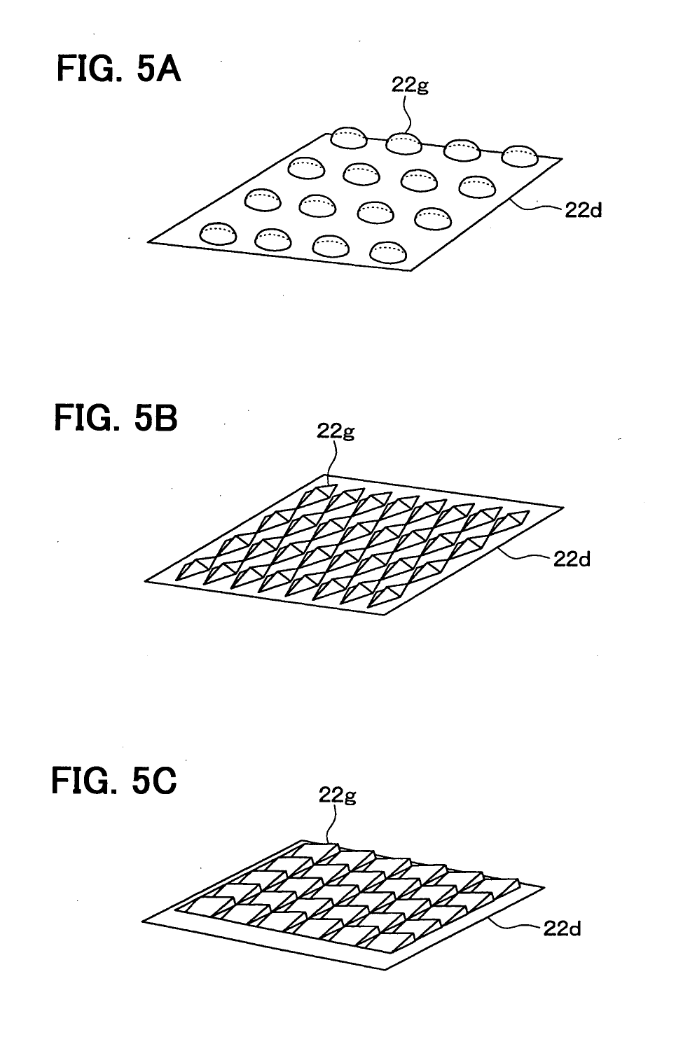

Next, a second embodiment of the present invention will be described with reference to FIG. 5. In the present embodiment, the parts different from those of the first embodiment will be mainly described.

FIGS. 5A to 5C are perspective views showing examples of a permeation film 22d. More specifically, FIG. 5A shows an example in which hemispherical protrusion portions 22g are formed on the permeation film 22d, FIG. 5B shows an example in which square pyramid protrusion portions 22g are formed on the permeation film 22d, and FIG. 5C shows an example in which scale-like protrusion portions 22g are formed on the permeation film 22d.

In the examples of FIGS. 5A to 5C, by providing the protrusion portions 22g on the surface of the permeation film 22d, the turbulent flow can be easily caused in the inside air and the outside air flowing near the surface of the permeation film 22d. Thus, it can prevent the inside air and the outside air from staying near the surface of the permeation film 22d, thereby improving the molecule exchange efficiency of the permeation film 22d. As a result, a necessary amount of ventilation for the gas required to permeate through the permeation film 22d can be reduced, and thereby the sizes of the blowers 17 and 23 can be effectively reduced.

In the second embodiment, the other parts are similar to those of the above-described first embodiment, and the effects described in the first embodiment can be obtained.

### Other Embodiments

Although the present invention has been fully described in connection with the preferred embodiments thereof with reference to the accompanying drawings, it is to be noted that various changes and modifications will become apparent to those skilled in the art.

For example, in the above-described embodiments, the air filter device of the present invention is typically applied to a vehicle air conditioner. However, the air filter device of the present invention may be used for the other device except for the vehicle air conditioner.

In the above-described embodiments, by using the turbulent flow generation portions 22e, 22f or the protrusion portions 22g of the permeation film 22d, the turbulent flow is generated in the inside air and the outside air flowing near the surface of the permeation film 22d. However, the air filter device may be configured such that the turbulent flow is caused in the inside air and the outside air flowing near the surface of the permeation film 22d by providing a vibrating portion for vibrating the permeation film 22d.

More specifically, as the vibrating portion for vibrating the permeation film 22d, a self-excited vibration means for vibrating the permeation film 22d by using the flow of the inside air and the outside air may be provided, or a vibrating means for directly vibrating the permeation film 22d may be adapted. As the self-excited vibrating means of the permeation film 22d, the fan shapes of the blowers 17, 23 may be modified so that the rotation speeds of the blowers 17, 23 may be irregularly changed, or an air passage shape of the outside air flow space 22a or the inside air flow space 22b on the upstream side of the permeation film 22d may be modified. Furthermore, as means for directly vibrating the permeation film 22d, a member (e.g., electromagnetic coil) that is electrically vibrated by an electrical current may be used, or a vibration permeating member (e.g., spring) for transmitting the vibrations of the blowers 17, 23 to the permeation film 22d may be adapted.

In the above-described first embodiment, both the first turbulent flow generation portion 22e for generating the turbulent flow to the inside air and the second turbulent flow generation portion 22f for generating the turbulent flow to the outside air are provided. However, one of the first turbulent flow generation portion 22e and the second turbulent flow generation portion 22f may be provided.

In the above-described second embodiment, the protrusion portions 22g are provided on the one side surface of the permeation film 22d. However, the protrusion portions 22g may be provided on both side surfaces of the permeation film 22d.

In the above-described second embodiment, the protrusion portions 22g are provided on the permeation film 22d. However, a turbulent flow generation portion (e.g., protrusion portions) may be provided upstream of the permeation film 22d in the flow direction of the outside air in the outside air passage 15 (outside air flow space 22a) or may be provided upstream of the permeation film 22d in the flow direction of the inside air in the inside air passage 16 (inside air flow space 22b).

Such changes and modifications are to be understood as being within the scope of the present invention as defined by the appended claims.

What is claimed is:

1. An air filter device comprising:
an outside air passage in which outside air flows;
an inside air passage in which inside air flows;
a permeation film arranged at a boundary portion between the outside air passage and the inside air passage and configured to cause specific gas to permeate through the permeation film between the outside air passage and the inside air passage, wherein one side surface of the permeation film is exposed to the outside air in the outside air passage and the other side surface of the permeation film is exposed to the inside air in the inside air passage;
an outside air blower located to generate a flow of the outside air in the outside air passage;
an inside air blower located to generate a flow of the inside air in the inside air passage; and
a turbulent flow generation portion configured to generate a turbulent flow in at least one of the outside air flowing through near the one side surface of the permeation film and the inside air flowing through near the other side surface of the permeation film.

2. The air filter device according to claim 1, wherein the turbulent flow generation portion is disposed upstream of the permeation film in at least one of the outside air passage and the inside air passage.

3. The air filter device according to claim 1, wherein the turbulent flow generation portion is protrusion portions provided on at least one of the one side surface and the other side surface of the permeation film.

4. The air filter device according to claim 1, wherein the turbulent flow generation portion is a vibrating member that causes the permeation film to be vibrated.

5. The air filter device according to claim 4, wherein the vibrating member is configured to generate a self-excited vibration in the permeation film due to the flow of at least one of the outside air in the outside air passage and the inside air in the inside air passage.

6. The air filter device according to claim 4, wherein the vibrating member is configured to directly vibrate the permeation film.

7. The air filter device according to claim 1, further comprising
a permeation film unit in which a plurality of the permeation films are stacked with each other, wherein the permeation film unit has therein an inside air flow space arranged between adjacent permeation films and an outside air flow space arranged between adjacent permeation films, wherein
the turbulent flow generation portion includes a first turbulent flow generating part protruding toward upstream from an upstream end of the permeation film in a flow direction of the inside air flowing in the inside air flow space, and a second turbulent flow generating part protruding toward upstream from an upstream end of the permeation film in a flow direction of the outside air flowing in the outside air flow space.

8. The air filter device according to claim 7, wherein
the first turbulent flow generating part is provided at least at an upstream side of the inside air flow space to generate turbulent flow of the inside air, and
the second turbulent flow generating part is provided at least at an upstream side of the outside air flow space to generate turbulent flow of the outside air.
